(19) United States
(12) Patent Application Publication
(10) Pub. No.: US 2011/0158153 A1
(43) Pub. Date: Jun. 30, 2011

(54) SYSTEM AND METHOD FOR TERMINAL RELAY AND RELAY TERMINAL

(76) Inventor: Haiyun Luo, Milpitas, CA (US)

(21) Appl. No.: 12/651,239

(22) Filed: Dec. 31, 2009

(51) Int. Cl. H04J 3/08

(52) U.S. Cl. 370/315

(57) ABSTRACT

The present invention discloses a system and a method for terminal relay and a relay terminal to improve the security and authenticity of the terminal relay. The system for the terminal relay includes a first terminal, a second terminal and a base station, where the first terminal is adapted to process information according to a packet data convergence protocol and transmit the information to the second terminal; the second terminal is adapted to receive the information from the first terminal and forward the information to the base station; and the base station is adapted to receive the information from the second terminal and parse the information according to the packet data convergence protocol.

### FIELD OF THE INVENTION

The present invention relates to wireless networks, and in particular, to a system and a method for terminal relay and a relay terminal.

### BACKGROUND OF THE INVENTION

Cellular relay is standardized in 2G, 3G, and Long Term Evolution (LTE) networks. A cellular relay station does not need a wired backhaul connection, therefore less expensive and more flexible than a full-fledged base station. Relay stations are usually deployed by carriers for temporary provisioning of additional capacity and emergency coverage.

Cellular relay exposes the following issues in reality.

1. Cellular relay significantly complicates the design and implementation. It necessitates significant updates to both the access networks and the core networks.

2. Cellular relay requires dedicated equipments. The acquisition, deployment, and maintenance of relay stations significantly increase the capital expenditure (CAPEX) and operating expenditure (OPEX) of a cellular network. The cost usually does not justify the limited benefits.

Cellular Area Network (CAN) is related to the mobile ad-hoc networks (MANET) and wireless mesh networks. MANET or mesh connects a group of wireless devices through their peer-to-peer wireless connections. The core technology of such networks is a multi-hop routing protocol, e.g., Ad hoc On-demand Distance Vector (AODV) or Dynamic Source Routing (DSR), which extends the network reach to indirectly connected networks. MANET and mesh are designed and usually applied in instant networking, outdoor wireless coverage, and military networking.

MANET and mesh networks expose the following issues when applied to terminal relay.

1. Security and authenticity are usually assumed in MANET and mesh networks. In the terminal relay, terminals belong to different owners where pre-established trust does not exist. It is a must to ensure the security and authenticity of the user traffic flowing through other terminals, and prevent other users from intercepting the packet contents or even hijacking the connection.

2. Incentives for carriers. Carriers are always extremely cautious when they come to enabling direct connections among their users. They are usually concerned of the potential erosion of the revenue from the legacy voice services and the emerging data applications. Furthermore, there is indeed a real security threat to the carrier network when individual terminals become gateways to the mobile infrastructure. Malicious traffic may be introduced and causes significant damages to the mobile network.

3. Incentive for mobile users. Mobile users have even more concerns regarding opening up their mobile devices to other users, most likely strangers. Besides security, authenticity, and service abuse, mobile users will worry about the compromise of privacy and excessive consumption of their battery power. While the former can be addressed by technical measures and the latter can be relieved by power-efficient designs, the involvement of mobile users and their contributions must be recognized and compensated by incentive mechanisms.

Therefore, the security and authenticity of the present terminal relay need to be improved.

### SUMMARY OF THE INVENTION

An object of the present invention is providing a system and a method for the terminal relay and a relay terminal to improve the security and authenticity of the terminal relay.

A system for terminal relay according to an embodiment of the present invention, including a first terminal, a second terminal and a base station, wherein:

the first terminal is adapted to process information according to a packet data convergence protocol (PDCP) and transmit the information to the second terminal;

the second terminal is adapted to receive the information from the first terminal and forward the information to the base station; and

the base station is adapted to receive the information from the second terminal and parse the information according to the packet data convergence protocol.

A method for terminal relay according to an embodiment of the present invention, including:

receiving, by a second terminal, information processed by a first terminal according to a packet data convergence protocol from the first terminal; and

forwarding, by the second terminal, the information to a base station to be parsed by the base station according to the packet data convergence protocol.

A relay terminal according to an embodiment of the present invention, including:

a receiving module, adapted to receive information processed by a served terminal according to a packet data convergence protocol from the served terminal; and

a first forwarding module, adapted to forward the information to a base station to be parsed by the base station according to the packet data convergence protocol.

According to the embodiments of the present invention, the first terminal processes information according to the packet data convergence protocol (PDCP) and transmits the information to the second terminal; the second terminal receives the information from the first terminal and forwards the information to the base station; and the base station receives the information from the second terminal and parses the information according to the PDCP. Since the PDCP includes the encryption and decryption of information in both the user plane and the control plane, with the security functions residing at the first terminal and the base station, the relayed information is protected from any interception or modifications at the second terminal that are not necessarily trusted by the first terminal, thus improving the security and authenticity of the terminal relay.

### BRIEF DESCRIPTION OF THE DRAWINGS

FIG. 1 is a structural representation of a system for the terminal relay according to an embodiment of the present invention;

FIG. 2 is a structural representation of a system for the terminal relay according to another embodiment of the present invention;

FIG. 3 is an example of the system for the terminal relay according to an embodiment of the present invention;

FIG. 4 is an LTE control plane protocol stack in the prior art;

FIG. 5 is an LTE user plane protocol stack in the prior art;

FIG. 6 is an LTE control plane protocol stack according to an embodiment of the present invention;

FIG. 7 is an LTE user plane protocol stack according to an embodiment of the present invention;

FIG. 8 is a flowchart of a method for the terminal relay according to an embodiment of the present invention;

FIG. 9 is a flowchart of a method for the terminal relay according to another embodiment of the present invention;

FIG. 10 is a structural representation of a relay terminal according to an embodiment of the present invention;

FIG. 11 is a structural representation of a relay terminal according to another embodiment of the present invention; and

FIG. 12 is an LTE's user registration process according to an embodiment of the present invention.

### DETAILED DESCRIPTION OF THE EMBODIMENTS

In order to improve the security and authenticity of the terminal relay, the embodiments of the present invention provide a system and a method for the terminal relay and a relay terminal. Now the present invention will be described in detail with reference to the drawings and the embodiments.

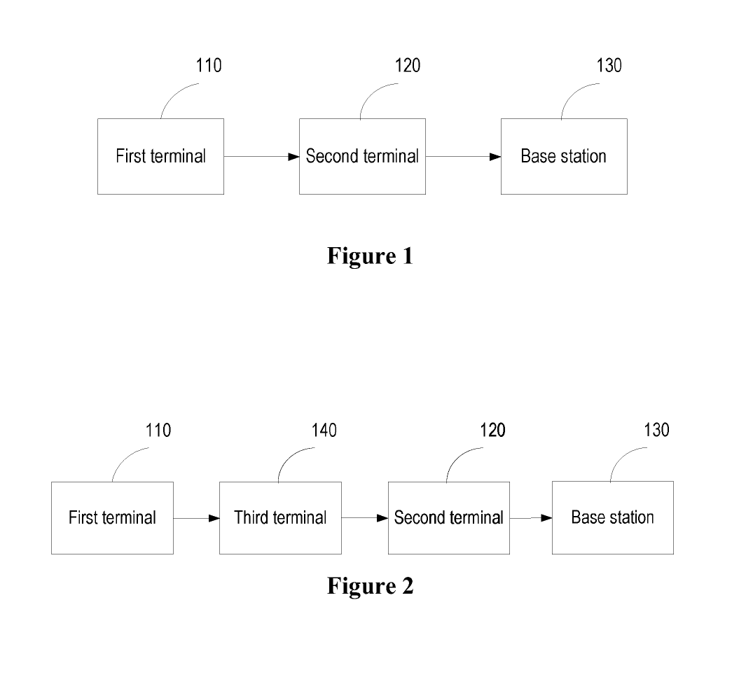

FIG. 1 is a structural representation of a system for the terminal relay according to an embodiment of the present invention. As shown in FIG. 1, the system includes a first terminal 110, a second terminal 120 and a base station 130, where:

the first terminal 110 is adapted to process information according to a PDCP and transmit the information to the second terminal 120;

the second terminal 120 is adapted to receive the information from the first terminal 110 and forward the information to the base station 130; and

the base station 130 is adapted to receive the information from the second terminal 120 and parse the information according to the PDCP.

Further, the system may include a third terminal 140, which is adapted to receive the information from the first terminal 110 and forward the information to the second terminal 120, as shown in FIG. 2.

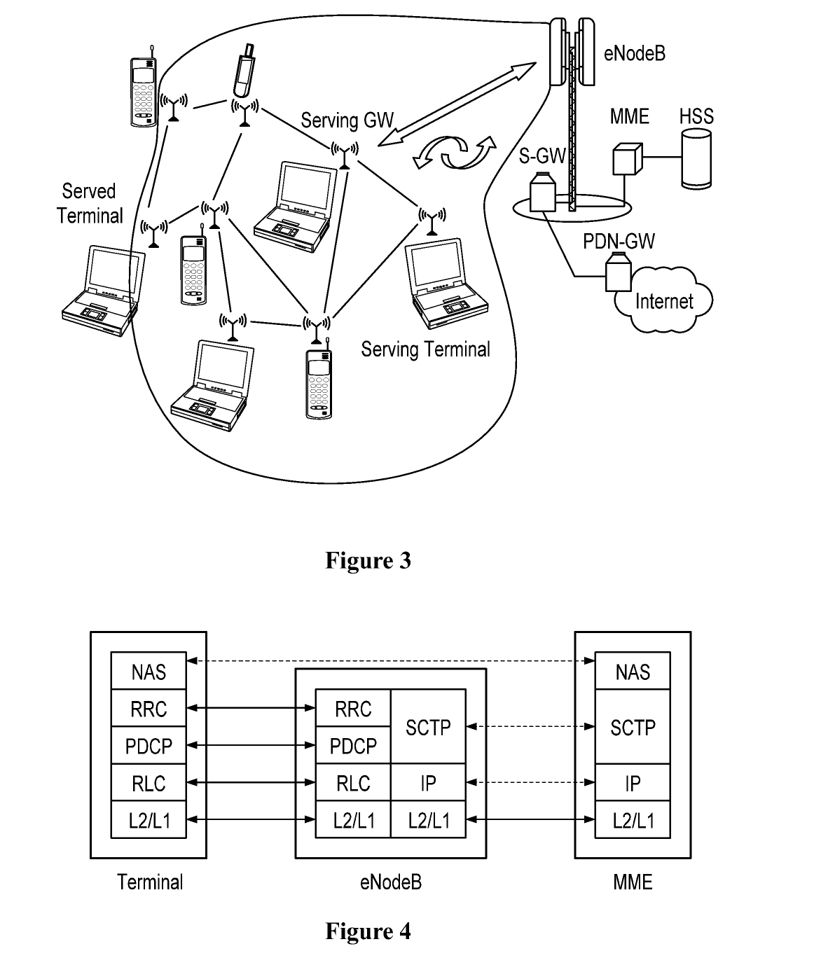

The terminal relay enables mobile terminals to relay traffic for each other via their direct connections. The mobile terminal can be a cell phone, a net-book computer, or other personal networked devices. The traffic can be either voice or data, to or from the Internet. The direct connections among mobile terminals can be established on top of their local area network interfaces, such as Wi-Fi, Bluetooth, or mobile radio interface such as GSM, CDMA, WCDMA, or LTE. With the local area network interfaces, a mobile terminal can reach the base station indirectly through other neighboring terminals. FIG. 3 is an example of the system for the terminal relay.

As shown in FIG. 3, an innovative CAN architecture for the terminal relay is disclosed. The goals of the CAN design are as follows.

Coverage extension. A terminal that is otherwise disconnected can establish connections with the base station through other terminals.

Throughput optimization. A terminal with poor channel conditions can route downlink/uplink packets through other terminals for higher end-to-end throughput and lower latency.

Herein define a CAN terminal as a user device that implements all or part of the CAN functionality. It can be a cell phone, a net-book computer, a portable computer, or other personal devices with a cellular interface. Herein also define a direct CAN terminal (the second terminal) as the one that maintains direct connections with a base station in both the control and user planes. In contrast, an indirect CAN terminal (the first terminal) does not have direct Radio Resource Control (RRC) connections with the base station. Only a direct CAN terminal may serve as a gateway CAN terminal (the second terminal), in that it may forward traffic to and from the base station. Any CAN terminal, direct or indirect, may serve as the relay CAN terminal (the third terminal) in that it forwards traffic to and from a gateway CAN terminal. Finally herein define a serving CAN terminal as a gateway or relay CAN terminal, and a served CAN terminal (the first terminal) that originates or receives packets through the CAN network.

Herein present the CAN design in the framework of LTE, but not limited, the latest 3GPP standard. Except for the physical layer inter-connectivity between CAN terminals, the overall CAN design applies equally to both Time Division Duplex (TDD)-LTE and Frequency Division Duplex (FDD)-LTE.

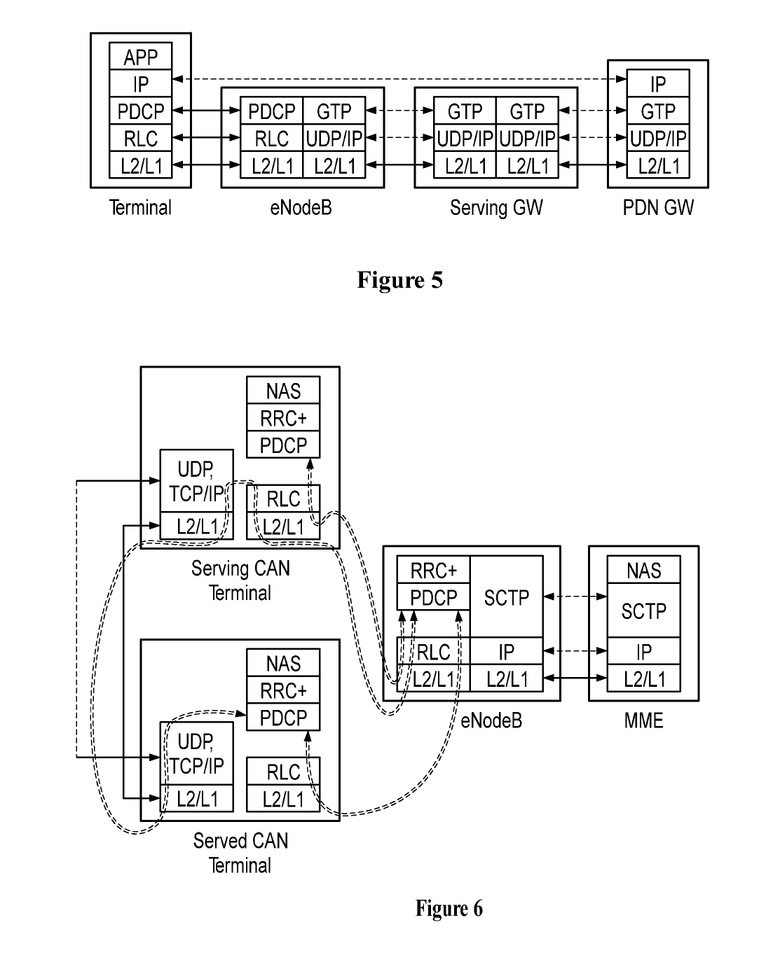

In the prior art, LTE protocol stack is divided into the control plane and the user plane, as illustrated in FIGS. 4 and 5. The detailed function specifications of the protocols, i.e., Network Attached Storage (NAS), RRC, PDCP, GPRS Tunneling Protocol (GTP), Radio Link Control (RLC), and Stream Control Transmission Protocol (SCTP), can be found in the corresponding 3GPP standards as a reference.

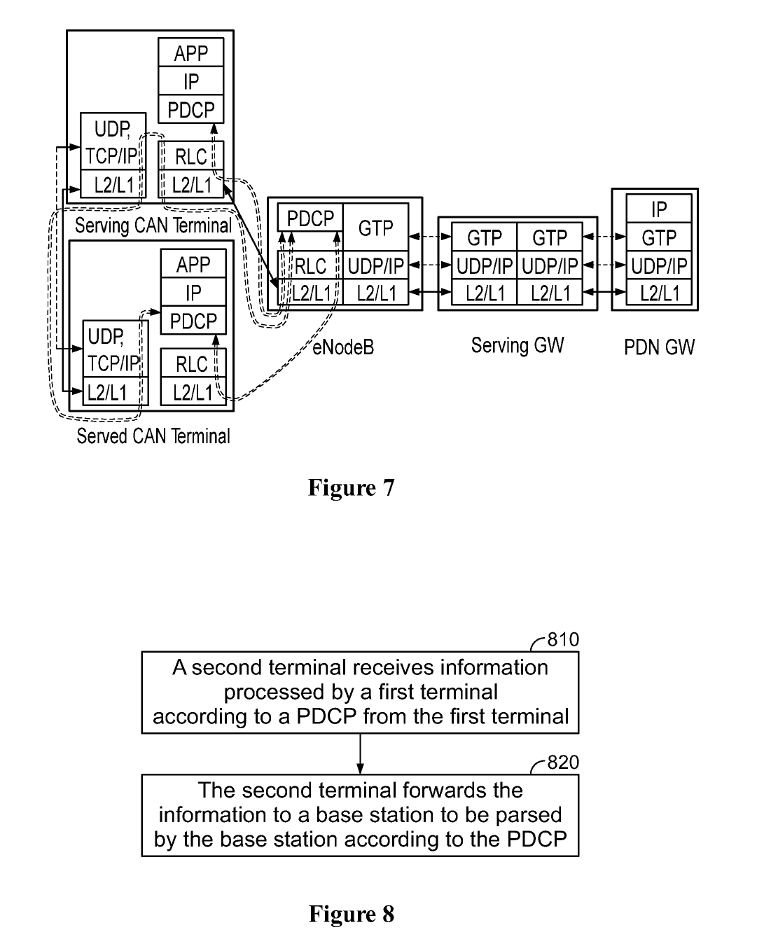

In an embodiment of the present invention, the CAN virtualizes the PDCP connection and allows indirect PDCP connection between a mobile terminal and the base station. FIGS. 6 and 7 show the architecture and protocol stack design in the context of LTE network. Herein assume that the CAN connections among the serving and served CAN terminals are based on IP, the network interface that is capable of running smoothly on almost all kinds of wireless radio interfaces. This interface also lends itself to mature IP routing technologies for the extension of a CAN connection into multiple hops.

As shown in FIGS. 6 and 7, the original connections between a terminal and an eNodeB are based on the LTE air interface; the new two-way CAN tunnel between a served CAN terminal and an eNodeB enables traffic to be transmitted from the served CAN terminal to the eNodeB via the serving CAN terminal or from the eNodeB to the served CAN terminal via the serving CAN terminal without parsing the traffic by the serving terminal.

Further, since the PDCP includes the encryption and decryption of traffic in both the user plane and the control plane, with the security functions residing at both ends of the tunnel, relayed traffic is protected from any interception or modifications at intermediate CAN terminals that are not necessarily trusted by the served terminal. If the tunnel is built at any protocol in upper layers, e.g., RRC for control plane and IP for user plane, additional security mechanisms would have to be introduced for security context setup and encryption/decryption primitive implementation. This would be a significant overhead and complexity increase. Furthermore, trust model has to be defined for key establishments, which is usually a non-technical, highly complex task. Therefore, the security and the authenticity of the terminal replay are improved greatly.

Moreover, this tunneling architecture reuses the QoS provisioning in LTE's air interface, including those at the RLC, Media Access Control (MAC), and Physical (PHY) layers. With an updated RRC at both eNodeB and the serving CAN terminal (marked as “RRC+” in FIGS. 6 and 7) to establish radio bearers for “remote” PDCP connections (the tunneled PDCP connections between a served CAN terminal and the eNodeB), the control signaling and traffic flows of the served CAN terminal enjoys the same level of QoS support at the serving CAN terminal's air interface. If choosing a lower layer, e.g., RLC, the original radio bearer concept would break and other related functions would have to be changed. Furthermore, RLC's Automatic Repeat request (ARQ) or MAC's Hybrid Automatic Repeat request (HARM) would not work well across CAN inter connections given the delay uncertainty.

FIG. 8 is a flowchart of a method for the terminal relay according to an embodiment of the present invention. As shown in FIG. 8, the method includes the following processes:

Process 810, a second terminal receives information processed by a first terminal according to a PDCP from the first terminal; and

Process 820, the second terminal forwards the information to a base station to be parsed by the base station according to the PDCP.

In process 810, the second terminal receives the information from the first terminal via a local area network interface, which may be Wi-Fi interface or Bluetooth interface.

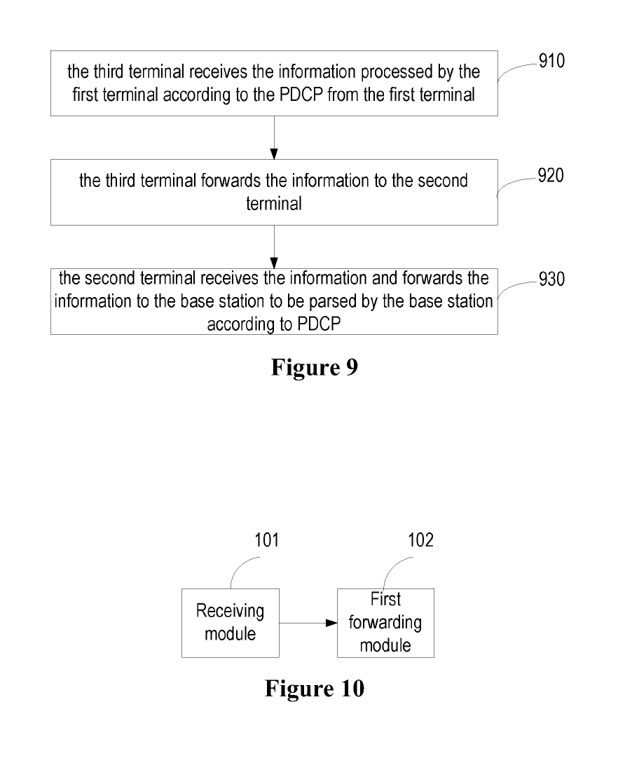

In an embodiment of the present invention, when a third terminal presents between the first terminal and the second terminal, a flowchart of the method for terminal relay is as shown in FIG. 9, the method includes the following processes:

Process 910, the third terminal receives the information processed by the first terminal according to the PDCP from the first terminal;

Process 920, the third terminal forwards the information to the second terminal; and

Process 930, the second terminal receives the information and forwards the information to the base station to be parsed by the base station according to PDCP.

According to the above described method, the information processed by the first terminal according to the PDCP can be transmitted to the base station via the second terminal without parsing the information by the second terminal, thus improving the security and the authenticity of the terminal relay greatly.

FIG. 10 is a structural representation of a relay terminal according to an embodiment of the present invention. As shown in FIG. 10, the relay terminal includes a receiving module 101 and a first forwarding module 102, where:

the receiving module 101 is adapted to receive information processed by a served terminal according to a PDCP from the served terminal; and

the first forwarding module 102 is adapted to forward the information to a base station to be parsed by the base station according to the PDCP.

In an embodiment, the receiving module 101 is further adapted to receive the information from the served terminal via a local area network interface, which may be Wi-Fi interface or Bluetooth interface.

In an embodiment, the relay terminal further includes a second forwarding module 103, as shown in FIG. 11, which is adapted to forward the information to another relay terminal.

Now three important procedures in the CAN architecture, including subscriber registration, communication sessions and mobility management, will be described.

1. User Registration

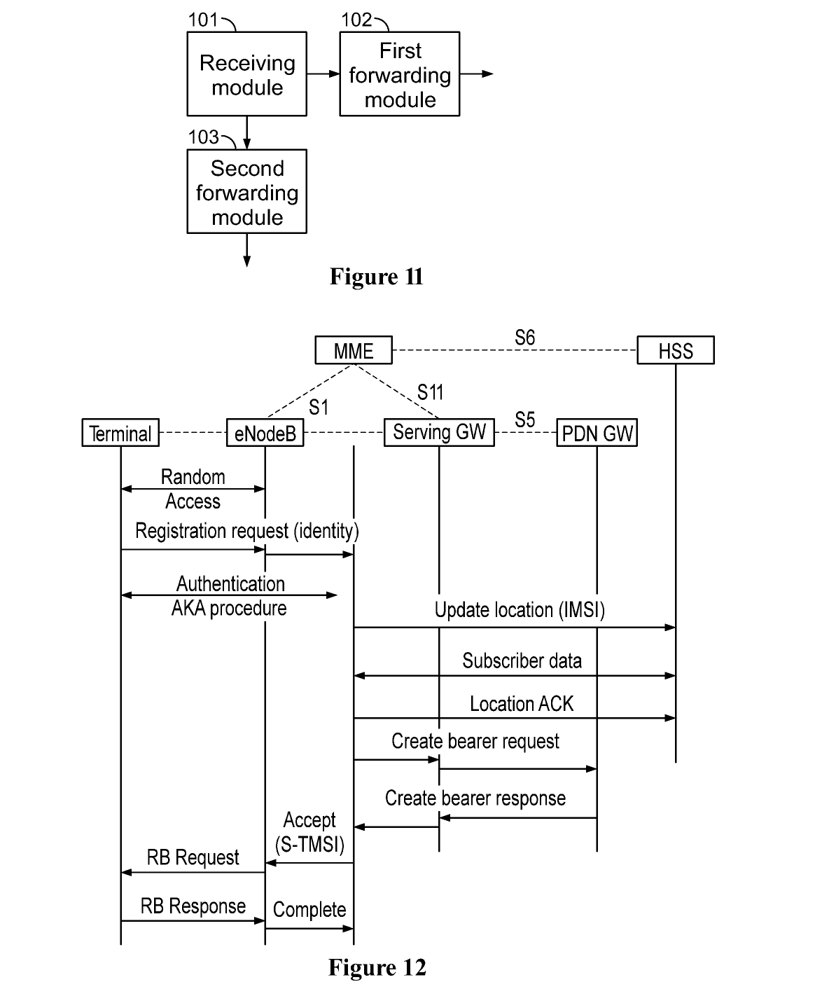

Note that user registration is not a new issue for direct CAN terminals, so our design focuses on indirect CAN terminals. All communications will have to go through other serving CAN terminals. LTE's user registration process can be illustrated in FIG. 12.

It can be seen from FIG. 12 that the user registration serves the following four main purposes.

1. Mutual authentication between the terminal and the network;

2. Temporary identity allocation;

3. User location registration;

4. Default bearer establishment.

The user location registration process is inclusive in the core network and does not impact CAN terminals. Mutual authentication and temporary identity allocation do not assume a trusted, secure channel. Therefore, the introduction of additional CAN connections into the communication path does not weaken the security or the privacy of temporary identity allocation. Finally for the default bearer establishment, GTP tunneling within the core network is not impacted by the CAN network. The only procedure that has to be tailored for the served CAN terminal is the radio bearer (RB) establishment procedure. It therefore involves changes to the RRC (marked as “RRC+”) as shown in FIG. 6.

Therefore, the LTE's subscriber registration process will be preserved, except for the bearer establishment at the LTE air interface. Since bearer establishment at air interface is between the eNodeB and the terminal and transparent to NAS, NAS protocol at the Mobility Management Entity (MME) side remains unchanged. As a result, no update needs to be performed on the MME.

2. Communication Sessions

As it is analyzed above, bearer activation and management will be complicated by CAN design only at the radio bearer part. Generally, the radio bearer must be more flexible in that the resources allocated for the radio bearers of the served CAN terminal might be temporarily occupied by the gateway CAN terminal to forward the traffic for the served CAN terminal. Detailed scheduling algorithms for the maximum radio bearer utilization are left as an implementation option.

To realize such highly dynamic scheduling, the scheduler at the eNodeB and the gateway CAN terminal must first be aware of each other and the bearer configurations for the target served CAN terminal. For downlink traffic, the eNodeB has such centralized information on bearer configurations. Additional mechanisms can be established through the dedicated control channel, for the served CAN terminals to report the CAN connectivity to the eNodeB. For uplink traffic, such bearer configuration information can be piggybacked into the traffic itself. As traffic flows through candidate gateway CAN terminals the uplink bearer configurations will be available.

Another issue of the highly dynamic scheduling is effective channel adaptation. Unlike the radio bearers of its own, the channel quality of another terminal might not have been established between the eNodeB and the gateway CAN terminal. Existing channel monitoring mechanisms can be extended to report an extended set of physical channels.

In the end of bearer activation, a PDCP connection that maps to the established radio bearer is established between the eNodeB and the indirect served CAN terminal. Such a PDCP connection is logically tunneled through the CAN network. As a result, the radio bearer is distributed among all candidate gateway CAN terminals. The change of the gateway CAN terminals or the CAN routing will not impact the radio bearer.

3. Mobility Management

Mobility management for direct CAN terminals remains the same as that defined in LTE. Therefore we only need to care about indirect CAN terminals. The cell selection for indirect CAN terminals will depend on its candidate gateway CAN terminals, and the issue is complicated by the scenarios that some candidate gateway CAN terminals might associate with different eNodeBs.

The cell selection for indirect CAN terminal is redefined as the gateway CAN terminal selection. A served CAN terminal makes the choice based on a number of factors, such as the network distance, the number of candidate gateway CAN terminals, the LTE radio bearer quality, and the battery power.

An indirect CAN terminal follows the existing LTE standard for tracking area update and handover, with or without the X2 interfaces. The difference is that such update and handover procedures are all executed through its serving gateway CAN terminals.

Moreover, note that PDCP ensures First-In First-Out (FIFO) packet delivery. It enables truly opportunistic eNodeB scheduling in that the scheduler (at MAC layer) dynamically distributes the packets of one PDCP connection either to a serving CAN terminal or directly to the served CAN terminal. Similarly, the scheduler at the served CAN terminal can send uplink packets directly through the LTE air interface or through the CAN inter connection. PDCP will reorder the packets that travel different routes.

A final issue to address is the incentive for the serving CAN terminals. Note that a terminal that is actively transmitting or receiving traffic will be motivated to collaborate in CAN for the increase of its own share of throughput. Furthermore, eNodeB can easily identify the gateway CAN terminal, evaluate its contribution, and credit it accordingly.

Overall, the PDCP connection between a mobile terminal and a base station is virtualized across multiple hops. It significantly expands the schedulable space of base station opportunistic scheduling. The PDCP connection travels through one or more CAN inter connections, and terminates at the PDCP protocol modules of the served CAN terminal and the eNodeB. Resource management on the Radio Access Network (RAN) uplink and downlink is virtualized. Resource blocks are allocated based on the final destination (served CAN terminal) and the channel quality of the gateway CAN terminal. It enables maximum reuse of the existing QoS provisioning at RAN. Subscriber registration process is virtualized across un-trusted CAN inter connections. Core network signaling and functionality for subscriber registration remain unchanged. It significantly reduces the complexity of key management and security maintenance. Radio bearer establishment is virtualized across un-trusted CAN inter connections. Core network bearer establishment and maintenance remain simple and unchanged.

It will be appreciated that one skilled in the art may make various modifications and alterations to the present invention without departing from the spirit and scope of the present invention. Accordingly, if these modifications and alterations to the present invention fall within the scope of the claims of the present invention and their equivalents, the present invention intends to include all these modifications and alterations.

1. A system for terminal relay, comprising a first terminal, a second terminal and a base station, wherein:
the first terminal is adapted to process information according to a packet data convergence protocol and transmit the information to the second terminal;
the second terminal is adapted to receive the information from the first terminal and forward the information to the base station; and
the base station is adapted to receive the information from the second terminal and parse the information according to the packet data convergence protocol.

2. The system of claim 1, wherein, the first terminal and the second terminal is connected via a local area network interface.

3. The system of claim 2, wherein, the local area network interface is Wi-Fi interface or Bluetooth interface.

4. The system of claim 1, wherein, the first terminal is further adapted to transmit the information via UDP, TCP/IP and L2/L1; the second terminal is further adapted to receive the information from the first terminal via L2/L1 and UDP, TCP/IP, and forward the information to the base station via RLC and L2/L1; and the base station is further adapted to receive the information from the second terminal via L2/L1 and RLC.

5. The system of claim 1, further comprising a third terminal, adapted to receive the information from the first terminal and forward the information to the second terminal.

6. A method for terminal relay, comprising:
receiving, by a second terminal, information processed by a first terminal according to a packet data convergence protocol from the first terminal; and
forwarding, by the second terminal, the information to a base station to be parsed by the base station according to the packet data convergence protocol.

7. The method of claim 6, wherein, the second terminal receives the information from the first terminal via a local area network interface.

8. The method of claim 7, wherein, the local area network interface is Wi-Fi interface, Bluetooth interface, or mobile radio interface.

9. The method of claim 6, wherein, the first terminal transmits the information via UDP, TCP/IP and L2/L1; the second terminal receives the information from the first terminal via L2/L1 and UDP, TCP/IP, and forwards the information to the base station via RLC and L2/L1;
and the base station receives the information from the second terminal via L2/L1 and RLC.

10. The method of claim 6, further comprising:
receiving, by a third terminal, the information from the first terminal; and
forwarding, by the third terminal, the information to the second terminal.

11. The method of claim 6, further comprising:
selecting, by the first terminal, the second terminal according to one or a combination of the following factors: a network distance, the number of the second terminals, radio bearer quality and battery power of the second terminal.

12. A relay terminal, comprising:
a receiving module, adapted to receive information processed by a served terminal according to a packet data convergence protocol from the served terminal; and
a first forwarding module, adapted to forward the information to a base station to be parsed by the base station according to the packet data convergence protocol.

13. The relay terminal of claim 12, wherein, the receiving module is further adapted to receive the information from the served terminal via a local area network interface.

14. The relay terminal of claim 13, wherein, the local area network interface is Wi-Fi interface, Bluetooth interface, or mobile radio interface.

15. The relay terminal of claim 12, wherein, the receiving module is further adapted to receive the information from the served terminal via L2/L1 and UDP, TCP/IP; and the first forwarding module is further adapted to forward the information to the base station via RLC and L2/L1.

16. The relay terminal of claim 12, further comprising:
a second forwarding module, adapted to forward the information to another relay terminal.
